(19) United States
(12) Patent Application Publication
(10) Pub. No.: US 2026/0259609 A1
(43) Pub. Date: Sep. 3, 2026

(54) VISCERAL SURFACE COVERING SIMULATOR AND METHOD OF USE

(71) Applicants: Aries Aviles, Bishop, GA (US); Grace Eberhard, Athens, GA (US); Katherine Crocker, Gainesville, GA (US); Lauren Pike, LaFayette, GA (US); Marial Walts, Atlanta, GA (US); Andy Strickland, Rome, GA (US); Katelyn Marianetti, Smyrna, GA (US); Shaw Industries Group, Inc., Dalton, GA (US)

(72) Inventors: Aries Aviles, Bishop, GA (US); Grace Eberhard, Athens, GA (US); Katherine Crocker, Gainesville, GA (US); Lauren Pike, LaFayette, GA (US); Marial Walts, Atlanta, GA (US); Andy Strickland, Rome, GA (US); Katelyn Marianetti, Smyrna, GA (US)

(21) Appl. No.: 18/717,580

(22) PCT Filed: Dec. 9, 2022
(86) PCT No.: PCT/US2022/081284

§ 371 Date: Jun. 7, 2024

Related U.S. Application Data
(60) Provisional application No. 63/265,249, filed on Dec. 10, 2021.

(51) Int. Cl. G06F 3/01; G06F 3/04815; G06F 3/16

(52) U.S. Cl. CPC G06F 3/016; G06F 3/04815; G06F 3/167; G06F 2200/1637

(57) ABSTRACT

Systems and methods for providing consumers with additional metrics, beyond visual characteristics, for remotely assessing the suitability and desirability of various surface coverings for a given space or project. A computing device, such as a smartphone, is capable of providing visceral feedback characteristics of the surface texture and material composition of a given surface covering in the form of haptic and/or auditory sensations.

### CROSS-REFERENCE TO RELATED APPLICATION

This application claims priority to U.S. Provisional Application No. 63/265,249, filed on Dec. 10, 2021, the entire content of which is incorporated herein by reference.

### BACKGROUND

Texture is an integral part of surface coverings, such as floor panels, wall panels, wallpapers, etc. Conveying the texture of surface coverings to a consumer has previously required providing physical samples of the surface coverings for the consumer to touch and feel. However, physical samples of surface coverings are space consuming and cost-intensive since the cost of the physical samples may not be recovered. In addition, the physical samples can be an ecological burden.

### BRIEF SUMMARY

The presently disclosed systems and methods pertain to providing consumers with other metrics, beyond visual characteristics, for remotely assessing the suitability and desirability of various surface coverings for a given space or project. Specifically, the present disclosure pertains to a computing device, such as a smartphone, which is capable of providing visceral feedback characteristics of a feel of a given surface covering (e.g., the surface texture, material composition, etc. of the given surface covering in the form of haptic and/or auditory sensations.

In a first aspect, the present disclosure pertains to a system for assessing one or more surface coverings, the system comprising a computing device including a display screen, a haptic controller, a gyroscopic accelerometer, a processor in communication with the display screen, a haptic controller, and a memory in communication with the processor; a library of different surface coverings; a visceral response file comprising sub files such as, but not limited to, a topology file, and a friction coefficient file for each surface covering; and a coordinating module, stored in the memory and implemented by the processor, for displaying an image of a selected surface covering on the display screen, displaying an image of a surface characterizing object on the display of the selected surface covering, sensing the movement of the computing device in response to output from the gyroscopic accelerometer, moving the image of the surface characterizing object with respect to the display of the selected surface covering, and generating a visceral response to the movement of the image of the surface characterizing object with respect to the display of the selected surface covering by selectively actuating the haptic controller by reference to the one or more sub files of the visceral response file.

In an alternative aspect, the system for assessing includes a data communications interface for selectively receiving remotely stored and accessible topology and coefficient of friction files for the various surface coverings, rather than an on-board library of such files, whereby topology and coefficient of friction files are accessed as required.

In an embodiment, the computing device of the system further comprises an audio speaker wherein generating a visceral response to the movement of the image of the surface characterizing object with respect to the display of the selected surface covering further comprises selectively generating an audible output from the audio speaker by reference to one or more sub files of the visceral response file.

In another embodiment, the surface characterizing object is projected as a flat or a three-dimensional object.

In another embodiment, the surface characterizing object is projected as a ball or a polyhedron.

In another embodiment, the surface characterizing object comprises plural objects.

In another embodiment, two or more candidate surface coverings can be displayed simultaneously, thereby allowing a user to move the object across one surface and then another for comparison purposes.

In another embodiment, the surface covering comprises carpet, hardwood, resilient, tile, stone, or wallpaper.

In a second aspect, the present disclosure pertains to a method of remotely assessing at least one quality of a candidate surface covering, the method comprising accessing a library of surface covering categories stored in a computing device; choosing a candidate surface covering from among the library; displaying an image of the chosen surface covering on a display of the computing device; displaying a virtual surface characterizing object with respect to the image of the chosen surface covering on the display of the computing device; manipulating the computing device; calculating and displaying movement of the virtual surface characterizing object with respect to the image of the chosen surface covering on the display of the computing device in response to the computing device manipulation; referencing one or more sub files of a visceral response file such as, but not limited to, topology and coefficient of friction files for the chosen surface covering stored in conjunction with the computing device; and generating visceral feedback, by the computing device, in response to the calculated movement of the virtual surface characterizing object and the one or more sub files of the visceral response file for the chosen surface covering.

In an embodiment, the step of generating visceral feedback comprises selectively actuating a haptic controller of the computing device in response to the calculated movement of the virtual surface characterizing object and the one or more sub files of the visceral response file for the chosen surface covering.

In another embodiment, the step of generating visceral feedback comprises selectively actuating an audio controller of the computing device in response to the calculated movement of the virtual surface characterizing object and the one or more sub files of the visceral response file for the chosen surface covering. In one or more embodiments, the computing device may be a portable computing device.

In an embodiment, the step of generating visceral feedback comprises selectively actuating an audio controller of the computing device in response to the calculated movement of the virtual surface characterizing object and the topology and coefficient of friction files for the chosen surface covering.

In an embodiment, the computing device comprises a smartphone.

In an embodiment, the library of surface coverings is remotely stored and accessible by a data communications interface for selectively receiving remotely stored an accessible topology and coefficient of friction files for various surface coverings.

In an embodiment, the surface characterizing object is projected as a flat or a three-dimensional object.

In an embodiment, the surface characterizing object is projected as a ball or a polyhedron.

In an embodiment, the surface characterizing object comprises plural objects.

In an embodiment, two or more candidate surface coverings can be displayed simultaneously, thereby allowing a user to move the object across one surface and then another for comparison purposes.

In an embodiment, the surface covering comprises carpet, hardwood, resilient, tile, stone, or wallpaper.

In an embodiment, the surface covering comprises a textile surface or a furniture surface.

In recent years, there has been a marked increase in online shopping for many types of consumer goods. This trend has been driven by factors including convenience of shopping from home or the office as well as a desire to avoid crowded public spaces.

Despite this trend, consumers have continued to rely upon in-store shopping for selecting surface coverings, such as flooring and wallpaper. While catalogs and online images provide visual information about surface covering choices, visual assessment alone does not give the consumer sufficient confidence that they are making the right choice for a given home renovation or other building or decorating project.

In addition to losing potential sales due to the perceived inconvenience or inadvisability of in-store shopping, retailers are forced to absorb the cost of loss-leading items such as wallpaper or flooring samples, with no guarantee that offering such samples will result in profitable sales. The distribution of such samples also comes with an ecological burden.

The presently disclosed system and method enhance the ability of a person to remotely assess surface coverings, beyond perusing visual imagery of candidate materials, thereby addressing the previously existing barriers to remote, online commerce for surface coverings such as flooring and wallpaper.

### BRIEF DESCRIPTION OF THE DRAWINGS

FIG. 1 is a plan view of a smartphone displaying various categories of surface coverings;

FIG. 2 is a perspective view of a user holding the smartphone of FIG. 1 as it displays both a selected candidate surface covering and a sphere as a virtual characterizing object;

FIG. 3 is a plan view of the smartphone of FIG. 1 displaying various candidate surface coverings in conjunction with a virtual characterizing object; and

FIG. 4 is a flowchart for a method of using the smartphone of FIG. 1 for assessing haptic and/or audible feedback with respect to candidate surface coverings.

### DETAILED DESCRIPTION OF EXEMPLARY EMBODIMENTS

Disclosed herein are systems and methods for using a computing device, such as a smartphone 10, for assessing candidate surface coverings 14 through the use of visceral feedback characteristic of the materials, i.e., surface coverings being assessed. The visceral feedback may be haptic and/or auditory feedback.

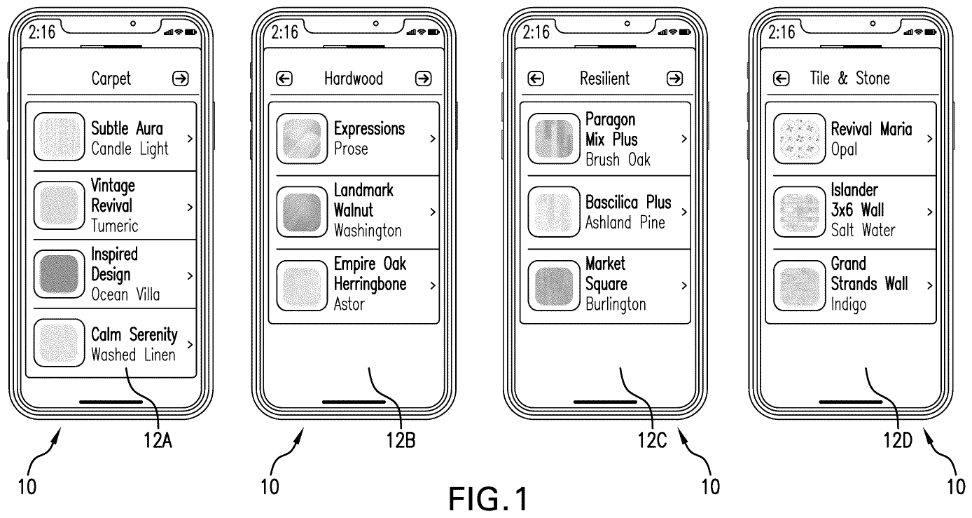

In FIG. 1, a smartphone 10 is used to display various categories of surface coverings. As illustrated, these include carpet 12A, hardwood 12B, resilient 12C, tile and/or stone 12D. Other categories are envisaged, including wallpaper, such as flocked wallpaper, bamboo wallpaper, printed wallpaper, etc.

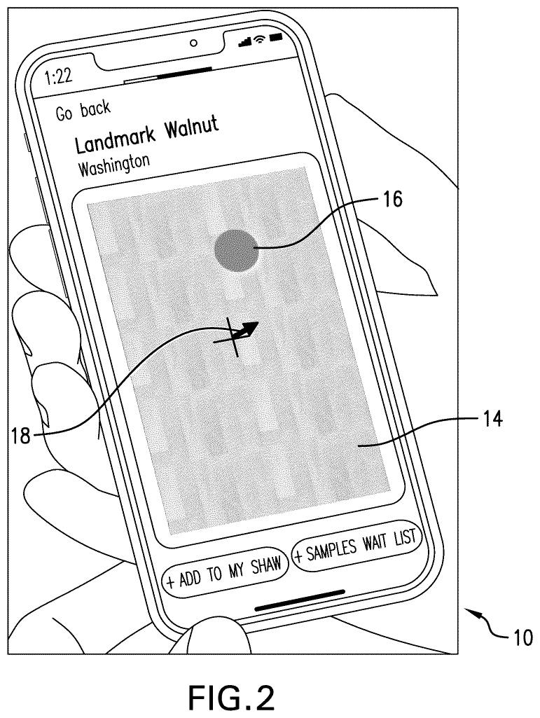

From among these categories, a user may choose a candidate surface covering 14, as shown in FIG. 2. In this example, the user has selected Landmark Walnut, which may have been chosen from the resilient category 12C. The user is thus presented with an image of a representative portion of flooring comprised of Landmark Walnut. In one embodiment, the image represents a portion of flooring as viewed from a given distance above the flooring, such as from one to six feet or more. The image may also represent a portion of the flooring as viewed from other distances above the flooring that may be closer than one foot or greater than six feet. In another embodiment, all candidate surface covering images are with respect to the same given distance for ease of comparison.

Projected onto the surface of the candidate surface 14 in FIG. 2 is a surface characterizing object 16 which, in the illustrated embodiment, is a ball. For example, the surface characterizing object may be overlaid on the image of the candidate surface. While shown as a circle, in other embodiments, the ball may be projected as a three-dimensional object. The user may be provided with the option of choosing from among a variety of objects, such as polyhedrons of a range of numbers of faces, wooden dowels, ping pong balls, etc. The user may also be provided with control over the size and material composition of the objects, including whether the objects are solid or hollow. Further, the user may be provided with the option of displaying one such object, or plural objects.

Once one or more surface characterizing objects 16 are chosen and are projected onto the displayed candidate surface 14, the user is capable of moving the object across the candidate surface by moving the smartphone 10 or other computing device about a virtual vertical axis 18, shown in FIG. 2 projecting from the display screen of the smartphone. The vertical axis is shown here for illustrative purposes and is not actually displayed to a user. Built-in gyroscopic accelerometers are capable of detecting this user movement and translating the movement into movement vectors for the surface characterizing object, taking into consideration the defined characteristics of the surface and the object. Stated differently, portions of the screen of the smartphone are raised and lowered with respect to horizontal. Lowering the top end of the smartphone with respect to the bottom end causes the surface characterizing object to appear to roll down the candidate surface towards the top of the screen. Likewise, lowering the right side of the smartphone with respect to the left side causes the object to appear to roll down to the right. A steeper angle of tilt will cause the object to appear to move across the surface faster.

As the surface characterizing object 16 appears to roll across the candidate surface covering 14, the smartphone 10 may respond in one or more ways that helps a user to assess the candidate surface covering. First, the smartphone may have an integrated haptic controller capable of providing tactile feedback to the user. For each candidate surface covering, the smartphone has associated therewith a visceral response file that includes, among other things, a topology file representative of the surface texture of the respective surface as well as data representative of a coefficient of friction for that surface. Using this data, and data representative of the chosen surface characterizing object, such as size, weight, composition, surface shape, and density, the haptic controller is operated to cause the user to sense tactile feedback through their fingers and/or palm as the user holds the smartphone in their hand such as over the palm and fingers representative of the surface characterizing object as it is moved by the user across the candidate surface. Providing feedback in this manner, and not through the use of swiping or otherwise moving the fingertip of the user over the display screen, avoids the sensory disconnect of receiving a sensation of roughness or surface texture through haptics while at the same time touching a smooth surface. The alternative to this disconnect is to employ a customized screen that enables the sensation of surface texture, but only through great cost and without the ubiquitous smartphone.

Second, the smartphone 10 has an external speaker from which may be presented audio samples representative of the selected surface characterizing object 16 moving with respect to the selected surface covering 14, again taking into consideration at least the topology file and coefficient of friction of the surface covering as well as characteristics of the chosen characterizing object.

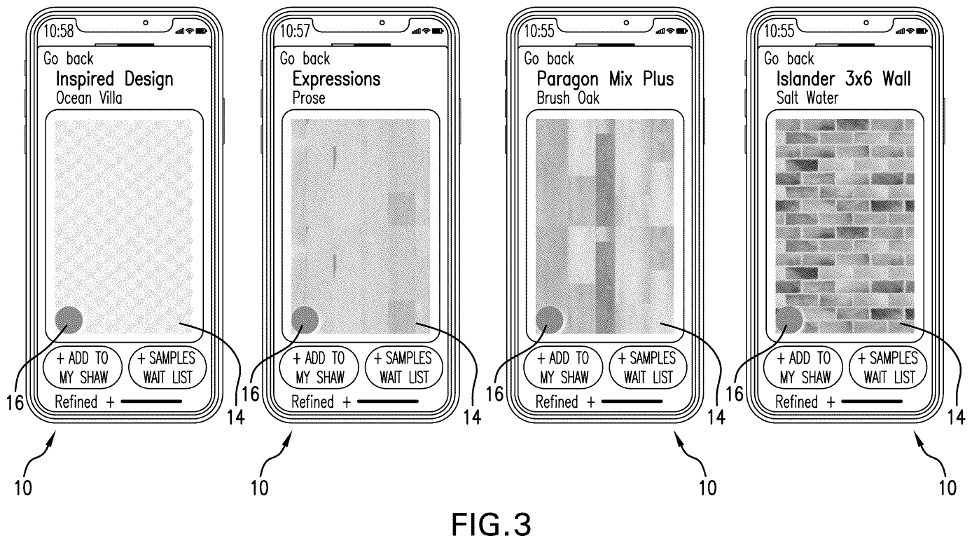

In FIG. 3, various candidate surface coverings 14 are displayed on the screen of the smartphone 10, along with a surface characterizing object 16. Thus, a user may assess the surface characteristics of each candidate surface covering one at a time. In an alternative embodiment (not illustrated), portions of two or more candidate surface coverings may be displayed simultaneously, allowing a user to move the object across one surface then another for comparison purposes. Various combinations of surface coverings may thus be presented and assessed as desired.

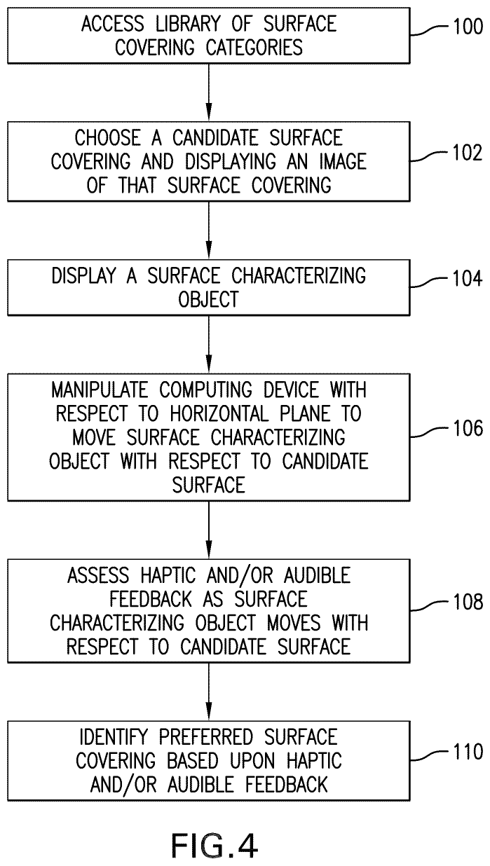

With respect to FIG. 4, a method of identifying a preferred surface covering from among a number of candidate surface coverings is presented. Using a computing device such as a smartphone, as depicted previously, a library of surface covering categories is accessed 100. A candidate surface covering is then chosen 102. Alternatively, a user may already have a candidate surface covering in mind and may skip the first step. The chosen surface covering is then displayed.

Once selected, the smartphone running software or firmware implementing the present method is configured to display a portion of the selected surface covering from a given standardized visual distance, which may or may not be customizable by the user, along with one or more surface characterizing objects 104 projected onto the selected surface covering.

The user is then capable of manipulating the computing device with respect to a horizontal plane such that the projected surface characterizing object moves over the selected surface covering 106. The software or firmware, having been provided with at least topology files and coefficient of friction data for each candidate surface covering as well as composition and surface data for the surface characterizing object, is capable of actuating the built-in haptic controller and/or audio controller of the smartphone to generate a visceral response to the virtual movement of the object with respect to the candidate surface, enabling the user to assess a measure of the surface characteristics.

Based upon this tactile and/or audible response, the user is able to identify and/or feel a preferred surface 110 without having access to a physical sample of the preferred surface.

While the present disclosure has been presented with respect to surface coverings such as wallpaper and flooring, it is understood that the present systems and methods may have applicability to a variety of surfaces to be assessed such as, but not limited to, textile, furniture, etc.

Alternative embodiments of the subject matter of this application will become apparent to one of ordinary skill in the art to which the present invention pertains, without departing from its spirit and scope. It is to be understood that no limitation with respect to specific embodiments shown here is intended or inferred.

What is claimed is:

1. A system for assessing one or more surface coverings, comprising:
a computing device comprising:
a display screen,
a haptic controller,
a gyroscopic accelerometer,
a processor in communication with the display screen, the haptic controller and the gyroscopic accelerometer, and
a memory in communication with the processor;
a library of surface coverings comprising for each surface covering:
a topology file, and
a friction coefficient file; and
a coordinating module, stored in the memory and implemented by the processor, for
displaying an image of a selected surface covering on the display screen,
displaying an image of a surface characterizing object on the display of the selected surface covering,
sensing the movement of the computing device in response to output from the gyroscopic accelerometer
moving the image of the surface characterizing object with respect to the display of the selected surface covering, and
generating a visceral response to the movement of the image of the surface characterizing object with respect to the display of the selected surface covering by selectively actuating the haptic controller by reference to the topology file and the friction coefficient file.

2. The system of claim 1, wherein the computing device further comprises an audio speaker, and wherein generating a visceral response to the movement of the image of the surface characterizing object with respect to the display of the selected surface covering further comprises selectively generating an audible output from the audio speaker by reference to the topology file and the friction coefficient file.

3. The system of claim 1, wherein the computing device comprises a smartphone.

4. The system of claim 1, wherein the library of surface coverings is remotely stored and accessible by a data communications interface for selectively receiving remotely stored an accessible topology and coefficient of friction files for various surface coverings.

5. The system of claim 1, wherein the surface characterizing object is projected as a flat or a three-dimensional object.

6. The system of claim 1, wherein the surface characterizing object is projected as a ball or a polyhedron.

7. The system of claim 1, wherein the surface characterizing object comprises plural objects.

8. The system of claim 1, wherein two or more candidate surface coverings can be displayed simultaneously, thereby allowing a user to move the object across one surface and then another for comparison purposes.

9. The system of claim 1, wherein the surface covering comprises carpet, hardwood, resilient, tile, stone, or wallpaper.

10. A method of remotely assessing at least one quality of a candidate surface covering, comprising:
accessing a library of surface covering categories stored in a computing device;
choosing a candidate surface covering from among the library;
displaying an image of the chosen surface covering on a display of the computing device;
displaying a virtual surface characterizing object with respect to the image of the chosen surface covering on the display of the computing device;
manipulating the computing device;
calculating and displaying movement of the virtual surface characterizing object with respect to the image of the chosen surface covering on the display of the computing device in response to the computing device manipulation;
referencing topology and coefficient of friction files for the chosen surface covering stored in conjunction with the computing device; and
generating visceral feedback, by the computing device, in response to the calculated movement of the virtual surface characterizing object and the topology and coefficient of friction files for the chosen surface covering.

11. The method of claim 10, wherein the step of generating visceral feedback comprises selectively actuating a haptic controller of the computing device in response to the calculated movement of the virtual surface characterizing object and the topology and coefficient of friction files for the chosen surface covering.

12. The method of claim 10, wherein the step of generating visceral feedback comprises selectively actuating an audio controller of the computing device in response to the calculated movement of the virtual surface characterizing object and the topology and coefficient of friction files for the chosen surface covering.

13. The method of claim 10, wherein the computing device comprises a smartphone.

14. The method of claim 10, wherein the library of surface coverings is remotely stored and accessible by a data communications interface for selectively receiving remotely stored an accessible topology and coefficient of friction files for various surface coverings.

15. The method of claim 10, wherein the surface characterizing object is projected as a flat or a three-dimensional object.

16. The method of claim 10, wherein the surface characterizing object is projected as a ball or a polyhedron.

17. The method of claim 10, wherein the surface characterizing object comprises plural objects.

18. The method of claim 10, wherein two or more candidate surface coverings can be displayed simultaneously, thereby allowing a user to move the object across one surface and then another for comparison purposes.

19. The method of claim 10, wherein the surface covering comprises carpet, hardwood, resilient, tile, stone, or wallpaper.

20. The method of claim 10, wherein the surface covering comprises a textile surface or a furniture surface.
